(19) United States
(12) Patent Application Publication
(10) Pub. No.: US 2010/0127561 A1
(43) Pub. Date: May 27, 2010

(54) REMOTE TRAILER BRAKE ACTIVATOR

(76) Inventor: Robert Stephen Bell, Carrum Downs (AU)

Correspondence Address: CHERNOFF, VILHAUER, MCCLUNG & STENZEL, LLP, 601 SW Second Avenue, Suite 1600, Portland, OR, 97204, US

(21) Appl. No.: 12/568,996

(22) Filed: Sep. 29, 2009

(30) Foreign Application Priority Data
Nov. 27, 2008 (AU) 2008906144

(51) Int. Cl. B60T 7/16

(52) U.S. Cl. 303/18

(57) ABSTRACT

A device for use with the air braking system of a vehicle of the type in which spring operated brakes are countered by air, has valves which charge and discharge the air storage tank of a trailer and an electronic receiver which switches the valves in response to phone and GPS signals. Discharge can proceed at two different rates in order to slow the trailer initially if the signal to brake is received while the trailer is travelling. The electronic receiver is also operable by a handheld signal generation in order to release the brakes and resume trailer travel.

### FIELD OF THE INVENTION

This invention concerns devices for assisting the recovery of stolen or abandoned vehicle trailers.

### BACKGROUND OF THE INVENTION

A typical brake for trucks and trailers uses two pneumatic circuits in its braking system. When braking is being effected air pressure in a compressed air supply line is lowered such that air is drawn from an auxiliary reservoir of compressed air through a central valve which is connected to a spring loaded brake cylinder containing a piston which in turn acts on a brake rod and brake shoe to effect braking.

When a trailer is disconnected its brakes are normally actuated. When a trailer is connected to a tractor or truck and connected compressed air passes through the supply line to disengage the brakes.

While this is an effective safety development which provides an air brake system which is locked when a trailer is detached, the ability of air brakes to be controlled by connection to a tractors braking system makes security problematic in that, once a trailer is connected to a truck or the like, the braking is deactivated.

It is known to monitor the journeys of tractor units and trailers on road systems so that in the event of theft the trailer can be located and recovered before the load is stolen. Trailers have braking systems in which the default position for the brakes is ON and the springs which apply the brakes are resisted by compressed air pressure. The same air pressure is utilised to apply the brakes during driving. While the trailer remains connected to the compressed air supply of the tractor, the trailer remains towable but as soon as the trailer is decoupled the air reservoir discharges and the brake springs ensure the trailer brakes are ON.

In US Patent No. 2007/0063582 A1 a security device is accommodated in an accessible box affixed to the trailer, the purpose being to house an exhaust valve which dumps air from the air reservoir when the box is unlocked. Unlocking the box gives access to the handle which opens and closes the valve.

### SUMMARY OF THE INVENTION

This invention provides a device for use with the air braking system of a vehicle of the type in which spring operated brakes are countered by compressed air, comprising a housing containing a pneumatic circuit for inclusion in the air braking system of the vehicle, couplings for connecting the pneumatic circuit to the braking system of the vehicle, valve means in the circuit to admit a compressed air supply in order to both charge the circuit and the braking system and to discharge the circuit and the braking system, phone signal receiving means capable of operating the valve means to both open and close the valve means thereby charging and discharging the air braking system.

In a preferred embodiment the circuit has a solenoid operated charging valve and a solenoid operated discharging valve both connected to an air storage tank, both the charging and discharging valves being connectable in parallel to the compressed air supply. The circuit between the discharging valve and the air storage tank has a throttle valve which slows the discharge through the discharge valve in order to secure two stage braking. The circuit between the throttle valve and the air storage tank has a pressure sensing switch which allows the valve means to charge the air storage tank when the tank pressure falls to a predetermined pressure. The phone signal activates a first electronic relay which operates the charge valve and a second electronic relay which operates the discharge valve.

The device further comprises a local electronic signal receiving means also capable of operating the valve means. In a preferred embodiment, the local electronic signal receiving means is an infrared sensor and the signal emission is generated by a portable remote control device for use by an authorised operator.

A GPS unit capable of emitting and receiving data operates the valve means in addition to the phone signal receiving means. An electronic circuit with a connection for the 24/12 v dc system of the tractor and a dry cell in the housing energizes the solenoid valves. The GPS unit has an aerial, the phone receiving means has an aerial and the infrared sensor has an aerial and both GPS and phone aerials exit the housing through a watertight seal. The housing has a vent for releasing air from the discharging solenoid valve and the vent has a waterproof seal. The vent is a chamber which communicates with the housing and contains multiple metal spheres. These dissipate the force of the released air. The valves, dry cell electronic circuit and pneumatic circuit are fixed to a baseplate mounted on resilient feet attached to the housing.

### BRIEF DESCRIPTION OF THE DRAWINGS

One embodiment of the invention is now described with reference to the accompanying drawings, in which:—

FIG. 1 is a diagrammatic view of part of the trailer to which the device is fixed.

FIG. 2 is a sectional view of the housing with the pipework omitted from the interior for clarity.

FIG. 3 is a pneumatic diagram of the device.

FIG. 4 is a circuit diagram of the device within the housing.

### DETAILED DESCRIPTION WITH RESPECT TO THE DRAWINGS

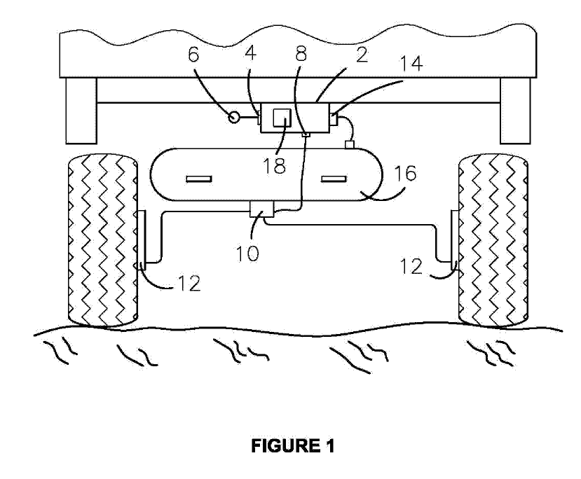

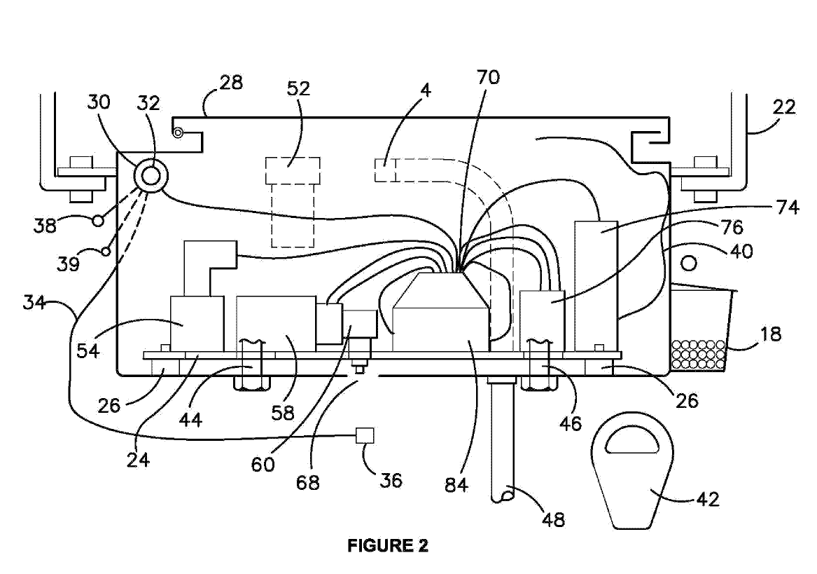

In FIGS. 1 and 2, the housing 2 is a steel box 400 mm×300 mm×150 mm. Pipe coupling 4 connects the device to the compressed air line 6 charged by the tractor's compressor (not shown). Coupling 8 connects the device to the spring brake control valve 10 which in turn supplies the brakes 12. Coupling 14 is connected to the air reservoir 16. A vent 18 connects the housing interior to the exterior. Vent 18 is a chamber which surrounds an aperture in the housing wall (see FIG. 2). The chamber is filled with small steel balls to prevent ingress of road dirt, snow and insects. It is closed by a flexible flap 20. The preferred site for the housing is the underside of the trailer above the reserve tank 16. It helps to select an inconspicuous site and to paint the housing the same colour as the trailer. Brackets 22 with one way nuts secure the housing to the trailer.

Baseplate 24 is mounted on rubber bushes 26 and fixed to the housing floor. Lid 28 is hinged to the top of the housing. Outlet 30 has a grommet 32 through which lead 34 enters. Lead 34 ends in a connector 36 for joining with the 12 v dc wiring loom of the trailer.

The gland also acts as an exit for a GPS aerial 38 and a longer GMS aerial 39 which wraps around the housing. An antenna 40 for a handheld remote 42 lies inside the housing.

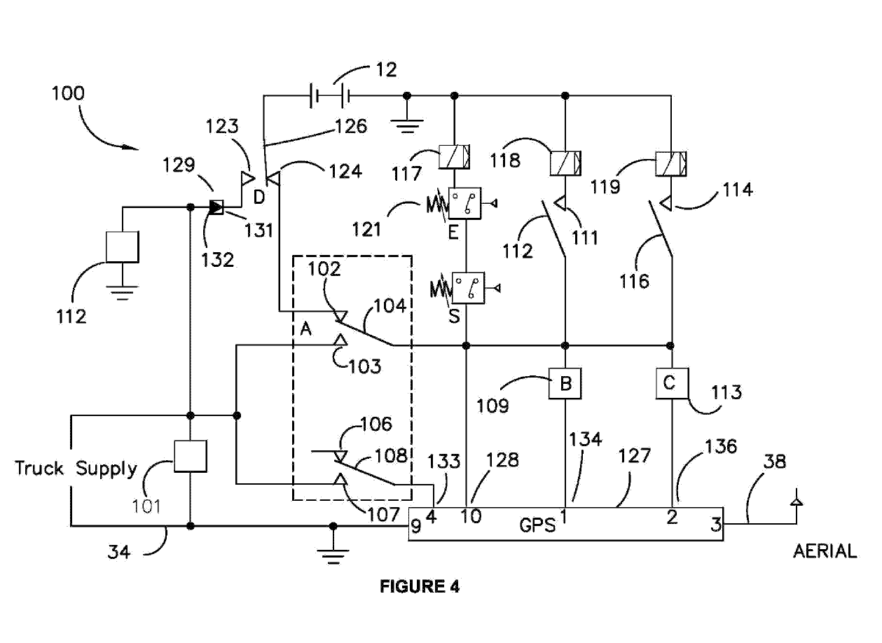

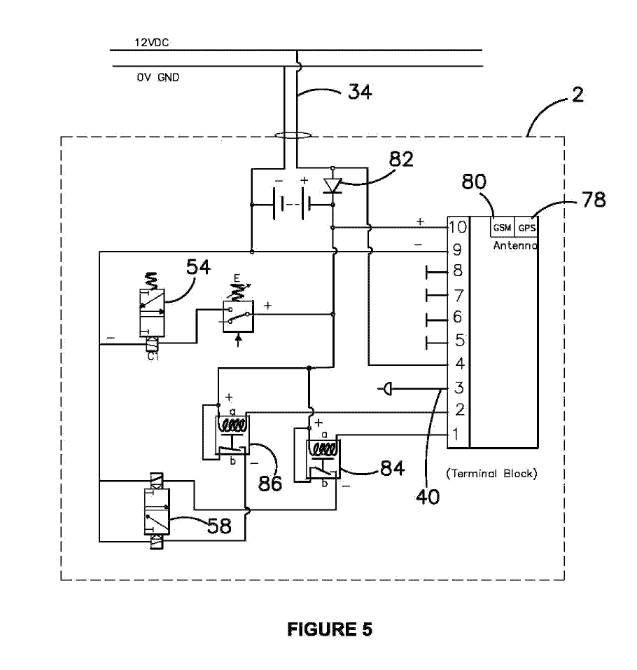

Apertures in the baseplate admit two ½″ pipes 44, 46 and these supply the pneumatic circuit shown in FIG. 4. Air from the tractor vehicle compressor reaches the housing 2 via ½″ pipe 48. It is admitted to filter 52 before entering the housing 2.

Pneumatic

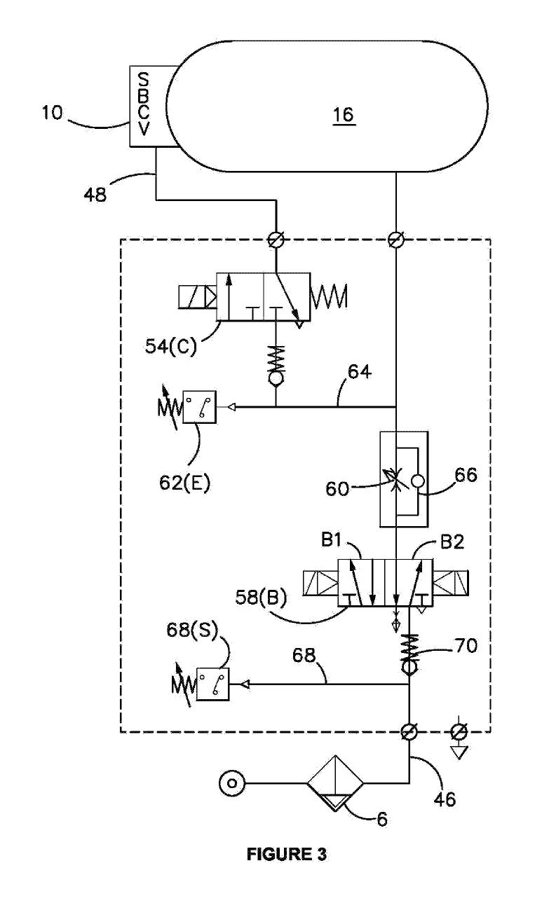

Referring now to FIG. 3, the air reservoir 16 both charges and discharges through solenoid valves 54 and 58. The reservoir connects to atmosphere through the spring brake control valve 10, and twin solenoid valves 54 and 58, which is normally closed. The valve discharges into the housing 2 and the housing discharges through the vent 18. When the twin solenoid valve 58 and valve 54 are in the charge position the air reservoir 16 is able to be charged.

Between coupling 8 and solenoid valve 58 there are in series an adjustable valve 60 and a pressure pneumatic switch 62 connected by leg 64. Bypass 66 is one way excess flow valve, so that when the air chamber 16 empties its diminishing pressure is sensed by the switch 62 and its discharge rate is predetermined by the setting of adjustable valve 60. In this way an initial fall from about 120 psi to 70 psi occurs in a controlled manner as the reservoir vents to atmosphere. The vehicles brakes are partially applied slowing the vehicle and indicating to the driver that an external signal has applied the brakes. The driver will still have 70 psi to operate the braking system. Valve 60 is adjusted and set to air flow rate at the time of installation to the individual vehicle by insertion of a tool in aperture 68 in the housing. Second leg 68 and one way valve 70 allow air escape at a different lower pressure. This route bypasses the activation procedure and permits the spring brake control valve to act as it normally would.

Electrical

Turning to FIG. 4, that figure illustrates the state of the circuit 100 when the trailer is disconnected from the trailer power supply 34.

A single-pole double-throw relay A has a solenoid 101, a pole 104 which is associated with normally-closed contact 102 and with normally-open contact 103. The solenoid 101 of relay A is connected across the tractor power supply 34. The pole 104 is connected at 128 to pin 10 of the GPS unit 127, and to relay solenoids 109 and 113 as described below. The normally-closed contact 102 of relay A is connected to relay D as is described below. The normally-open contact 103 of relay A is connected to the positive line of the tractor power supply 34. Contact Pin 4 of the GPS unit 127 is connected at 128 to pin 10 of the GPS unit.

A single-pole single-throw relay B has a solenoid 109, a pole 112 and a normally-open contact 111 which in turn is connected to one contact of a solenoid valve 118, which is also labelled as B2 in the drawings. The other contact of the solenoid valve 118 is connected to ground. The pole 112 of the relay B is connected at 128 to the pin 10 of the GPS unit 127. The solenoid 109 of relay B is connected at 128 to pin 10 of the GPS unit and at 134 to pin 1 of the GPS unit.

A single-pole single-throw relay C has a solenoid 113, a pole 116 and a normally-open contact 114 which in turn is connected to one contact of a solenoid valve 119, which is also labelled as B1 in the drawings. The other contact of the solenoid valve 119 is connected to ground. The pole 116 of the relay C is connected at 128 to pin 10 of the GPS unit 127. The solenoid 113 of the relay C is connected at 128 to pin 10 of the GPS unit and at 136 to pin 2 of the GPS unit 127.

A single-pole double-throw relay D has a solenoid 122, a double-throw pole 126, a normally-closed contact 124 and a normally-open contact 123. The pole 126 of the relay D is connected to the positive terminal of the battery 12. The normally-open contact 123 is connected to the cathode 131 of diode 129. The normally-closed contact 124 is connected to the normally-closed contact 102 of the relay A.

The pressure switch 121, which is also labelled as E in the drawings, has one terminal which is connected to a terminal of the solenoid valve 117, which is also labelled as C1 in the drawings, while another terminal of the pressure switch E is connected to one terminal of pressure switch S. The second terminal of pressure switch S is connected at 128 to the pin 10 of the GPS unit 127.

Pin Arrangement of GPS Unit (G)

| | | | |
|---|---|---|---|
| Pin 1. | UNLOCK (Pulse) | Pin 2. | LOCK (Pulse) |
| Pin 3. | Handheld Remote Antenna | Pin 4. | IGNITION Input |
| Pin 9. | Ground | Pin 10. | MAIN POWER |
| | | | (+12 VDC) |

Operation

When the tractor power supply 34 is connected to the circuit 100, relay A is in the energized state. When relay A is energized, its pole 104 is in contact with normally-open contact 103. The GPS unit 127 is thus energized from the tractor power supply 34 through the normally-open contact 107 and the pole 108. An “ignition on” signal is also supplied at 133 to pin 4 of the GPS unit. The solenoid 109 of relay B and the solenoid 113 of relay C can be energized by tractor power through normally-open contact 103 and pole 104 if an unlock or lock signal is received by the GPS unit.

The solenoid 122 of relay D is also energized from the tractor power supply 34 and connects the internal battery 12 to the tractor power supply 34.

When the tractor ignition power is turned off, relay D de-energizes and pole 126 is in contact with the normally-closed contact 124 and connects the internal battery 12 to the normally-closed contact 102 of relay A. The coil 101 of relay A is de-energized. Pole 104 of relay A then moves to the normally-closed contact 102. Pole 104 of relay A provides power to pin 10 of the GPS unit at 128. When pole 104 is on the normally-closed contact 102, the solenoid 109 of relay B and the solenoid 113 of relay C can be energized by the internal battery 12 through normally-closed contact 102 and pole 104 if an unlock or lock signal is received by the GPS unit.

If a lock signal is received by the GPS unit 127 the solenoid 113 of relay C energizes resulting in closing the normally-open contact 114 and the energization of solenoid valve 119, also shown as coil B1 in the drawings. This will result in the valve 119 venting air from the tank 16 through a fixed orifice in the V60 valve. The pressure in the tank 16 then drops to the predetermined value which has been set by the pressure switch 121, which is also shown as E in the drawings. When this value is reached solenoid valve 117, shown as C1 in the drawings, will de-energize which will vent the spring brake valve 10.

The result is that the system is exhausted of air and the brakes are on.

When the apparatus 100 is subsequently re-connected to the tractor power supply 34, and supplied with an “unlock” command from the handheld remote 42, the relay solenoid 109 of relay B is energized, the contact 111 closes and the solenoid valve 118, which is also shown as B2 in the drawings, energizes. The energization of solenoid valve 111 allows air from the tractor compressor to charge the tank 16. When air pressure reaches a pre-determined value, switch 121, which is also shown as E in the drawings, will energize the solenoid valve 117, which is also shown as C1 in the drawings, allowing flow of air through the spring brake valve 10 to charge the brakes.

The operation of the second pressure switch S is as follows. When the tractor hand brake is applied, air to the unit 100 is removed. This drop in pressure is detected by pressure switch S 120 and causes coil 117, also shown as C1 in the drawings, to de-energize. This will vent the spring brake valve causing the brakes to be applied. When the tractor hand brake is disengaged air is restored to the unit 100. The application of air is detected by pressure switch S 120 and causes coil 117 to energize. Tractor air is now able to charge the spring brake valve and the brakes relaxed.

20090604 component list

| | |
|---|---|
| 100. | electric circuit |
| 101. | solenoid of relay A |
| 102. | contact of relay A |
| 103. | contact of relay A |
| 104. | pole of relay A |
| 106. | contact of relay A |
| 107. | contact of relay A |
| 108. | pole of relay A |
| 109. | solenoid of relay B |
| 111. | contact of relay B |
| 112. | pole of relay B |
| 113. | solenoid of relay C |
| 114. | contact of relay C |
| 116. | pole of relay C |
| 117. | solenoid valve C1 |
| 118. | solenoid valve B2 |
| 119. | solenoid valve B1 |
| 120. | pressure switch S |
| 121. | pressure switch E |
| 122. | solenoid of relay D |
| 123. | contact of relay D |
| 124. | contact of relay D |
| 126. | pole of relay D |
| 127. | GPS unit |
| 128. | pin 10 of GPS unit 127 |
| 129. | diode |
| 131. | cathode of diode |
| 132. | anode of diode |
| 133. | pin 4 of GPS unit 127 |
| 134. | pin 1 of GPS unit 127 |
| 136. | pin 2 of GPS unit 127 |

Sequence of Drivers Operation

The driver couples the trailer to the truck by connecting a flexible air hose between the compressed air system of the truck to the compressed air system of the brakes. The truck's 12 v dc system is switched on by the ignition switch. The engine starts and the truck compressor charges the air reservoir to the brakes. The brakes of the truck are OFF and the truck and trailer commence their journey.

If the driver pulls in for a temporary stop switching off the ignition also switches off the 12 v dc. The truck unit activates the air reservoir exhausts and the brakes are ON.

If the truck or trailer are stolen or leaves the designated route, which can be divided into stages for monitoring purposes, the trucking overseer obtains a GPS fix and sends a telephone command to the GPS which triggers the valve system into active mode. This applies the brakes. If the vehicle or trailer are parked, the vehicle is immobilized and the police are advised of its location If the vehicle is mobile, the brakes come ON and the truck slows noticeably giving the driver time to change lanes and park off the road. By that time the air reservoir is discharging and the truck is immobilized.

When the owner or the police has secured the vehicle the unit can be restored to a mobile state by way of telephone command to deactivate and the GPS triggers the valves will close to allow air into the reservoir, returning the braking system to normal state.

We have found the advantages of the above embodiment to be:

1. Manual operation of the air valve is replaced by signal operation.

2. The system responds to both signals from telephone or GPS systems and local signals provided by a driver.

3. Two stage pressure loss gives the driver time to pull off the road and bring the tractor and trailer to a safe stop using the lowered pressure to apply the brakes.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

What is claimed is:

1. A device for use with the air braking system of a vehicle of the type in which spring operated brakes are countered by compressed air, comprising a housing containing a pneumatic circuit for inclusion in the air braking system of the vehicle, couplings for connecting the pneumatic circuit to the braking system of the vehicle, valve means in the circuit to admit a compressed air supply in order to both charge the circuit and the braking system and to discharge the circuit and the braking system, phone signal receiving means capable of operating the valve means to both open and close the valve means thereby charging and discharging the air braking system.

2. A device as claimed in claim 1, wherein the circuit has a solenoid operated charging valve and a solenoid operated discharging valve both connected to an air storage tank, both the charging and discharging valves being connectable in parallel to the compressed air supply.

3. A device as claimed in claim 2, wherein the circuit between the discharging valve and the air storage tank has a throttle valve which slows the discharge through the discharge valve in order to secure two stage braking.

4. A device as claimed in claim 3, wherein the circuit between the throttle valve and the air storage tank has a pressure sensing switch which allows the valve means to charge the air storage tank when the tank pressure falls to a predetermined pressure.

5. A device as claimed in claim 2, wherein the phone signal activates a first electronic relay which operates the charge valve and a second electronic relay which operates the discharge valve.

6. A device as claimed in claim 1, further comprising a local electronic signal receiving means also capable of operating the valve means.

7. A device as claimed in claim 6, wherein the local electronic signal receiving means is a infrared sensor and the signal emission is generated by a portable remote control device for use by an authorised operator.

8. A device as claimed in claim 6, wherein a GPS unit capable of emitting and receiving data operates the valve means in addition to the phone signal receiving means.

9. A device as claimed in claim 2, wherein an electronic circuit with a connection for the 24/12 v dc system of the tractor and a dry cell in the housing energizes the solenoid valves.

10. A device as claimed in claim 8, wherein the GPS unit has an aerial, the phone receiving means has an aerial and the infrared sensor has an aerial and both GPS and phone aerials exit the housing through a watertight seal.

11. A device as claimed in claim 2, wherein the housing has a vent for releasing air from the discharging solenoid valve and the vent has a waterproof seal.

12. A device as claimed in claim 11, wherein the vent is a chamber which communicates with the housing and contains multiple metal spheres.

13. A device as claimed in claim 9, wherein the valves, dry cell electronic circuit and pneumatic circuit are fixed to a baseplate mounted on resilient feet attached to the housing.
